(19) United States
(12) Patent Application Publication
(10) Pub. No.: US 2015/0340146 A1
(43) Pub. Date: Nov. 26, 2015

(54) MAGNETIZING DEVICE AND MAGNETIZING METHOD OF ROTOR CORE

(71) Applicant: TOYOTA JIDOSHA KABUSHIKI KAISHA, Toyota-shi (JP)

(72) Inventors: Masayuki MATSUSHITA, Toukai-shi (JP); Hirotaka Mori, Nagoya-shi (JP); Hiroaki Urano, Miyoshi-shi (JP)

(73) Assignee: TOYOTA JIDOSHA KABUSHIKI KAISHA, Toyota-shi (JP)

(21) Appl. No.: 14/712,015

(22) Filed: May 14, 2015

(30) Foreign Application Priority Data
May 22, 2014 (JP) 2014-105818

(51) Int. Cl. H01F 13/00

(52) U.S. Cl. CPC H01F 13/003

(57) ABSTRACT

A magnetizing device of a rotor core capable of suppressing deformation of electromagnetic steel sheets is provided. A magnetizing device of a rotor core according to one aspect of the present invention is a magnetizing device of a rotor core in which electromagnetic steel sheets are laminated. The magnetizing device includes: a magnetizing yoke to magnetize the rotor core; and holding means for holding peripheries of the electromagnetic steel sheets that are laminated from a direction in which the electromagnetic steel sheets are laminated. It is therefore possible to suppress deformation of the electromagnetic steel sheets.

### INCORPORATION BY REFERENCE

This application is based upon and claims the benefit of priority from Japanese patent application No. 2014-105818, filed on May 22, 2014, the disclosure of which is incorporated herein in its entirety by reference.

### BACKGROUND OF THE INVENTION

1. Field of the Invention

The present invention relates to a magnetizing device and a magnetizing method of a rotor core, and more specifically, for example, a magnetizing device and a magnetizing method of a rotor core in which electromagnetic steel sheets are laminated.

2. Description of Related Art

A rotor core mounted on a motor includes, as shown in FIG. 6, electromagnetic steel sheets 101 that are laminated. In order to prevent peripheries of the electromagnetic steel sheets 101 from being deformed in a direction in which the electromagnetic steel sheets 101 are laminated due to a suction power by a magnetizing yoke 102 of a magnetizing device when the rotor core is magnetized, the rotor core according to a prior art includes end plates 103 that hold the electromagnetic steel sheets 101 that are laminated from the direction in which the electromagnetic steel sheets 101 are laminated.

Meanwhile, a magnetizing device disclosed in Japanese Unexamined Patent Application Publication No. 2007-68298 includes an insulating winding protector disposed between winding wires in order to prevent a short circuit between the winding wires that are adjacent to each other in a magnetizing yoke.

A typical rotor core suppresses deformation of the electromagnetic steel sheets 101 by the end plates 103. However, since the end plates 103 are expensive, it is preferable that the end plates 103 be omitted. If the end plates 103 are omitted, however, as shown in FIG. 7, the electromagnetic steel sheets 101 are deformed due to the suction power by the magnetizing yoke 102 of the magnetizing device when the rotor core is magnetized.

### SUMMARY OF THE INVENTION

The present invention has been made in view of the aforementioned circumstances and aims to provide a magnetizing device and a magnetizing method of a rotor core capable of suppressing deformation of electromagnetic steel sheets when the rotor core is magnetized.

A magnetizing device of a rotor core according to one aspect of the present invention is a magnetizing device of a rotor core in which electromagnetic steel sheets are laminated, the magnetizing device including: a magnetizing yoke to magnetize the rotor core; and holding means for holding peripheries of the electromagnetic steel sheets that are laminated from a direction in which the electromagnetic steel sheets are laminated.

Accordingly, it is possible to magnetize the rotor core in a state in which the peripheries of the electromagnetic steel sheets that are laminated are held from the laminating direction of the magnetizing device. Accordingly, even when the rotor core is not equipped with the end plate, it is possible to suppress deformation of the electromagnetic steel sheets due to the suction power by the magnetizing yoke when the rotor core is magnetized.

In the magnetizing device of the rotor core stated above, an accommodation part that accommodates a projection part that is projected in the direction in which the electromagnetic steel sheets are laminated from the rotor core is preferably formed on a plane of the holding means that is opposed to the electromagnetic steel sheets.

Accordingly, it is possible to appropriately hold by the holding means the peripheries of the electromagnetic steel sheets that are laminated even when the projection part is projected from the rotor core.

A magnetizing method of a rotor core according to one aspect of the present invention is a magnetizing method of a rotor core in which electromagnetic steel sheets are laminated, the magnetizing method including holding peripheries of the electromagnetic steel sheets that are laminated from a direction in which the electromagnetic steel sheets are laminated when the rotor core is magnetized.

Accordingly, it is possible to magnetize the rotor core in a state in which the peripheries of the electromagnetic steel sheets that are laminated are held from the laminating direction of the magnetizing device. Accordingly, even when the rotor core is not equipped with the end plate, it is possible to suppress deformation of the electromagnetic steel sheets due to the suction power by the magnetizing yoke when the rotor core is magnetized.

According to the present invention, it is possible to provide a magnetizing device and a magnetizing method of a rotor core capable of suppressing deformation of electromagnetic steel sheets when the rotor core is magnetized.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a longitudinal cross-sectional view schematically showing a state in which a rotor core is magnetized using a magnetizing device according to an embodiment;

FIG. 2 is a parallel cross-sectional view schematically showing a state in which the rotor core is magnetized using the magnetizing device according to the embodiment;

FIG. 3 is a perspective view schematically showing the rotor core and the magnetizing device according to the embodiment;

FIG. 4 is a longitudinal cross-sectional view schematically showing a state in which the rotor core is held using holding means that is configured to be able to receive a projection part that is projected from the rotor core;

FIG. 5 is a parallel cross-sectional view of a second pressing part that is configured to be able to receive the projection part that is projected from the rotor core;

FIG. 6 is a longitudinal cross-sectional view schematically showing a state in which a rotor core equipped with an end plate is magnetized; and

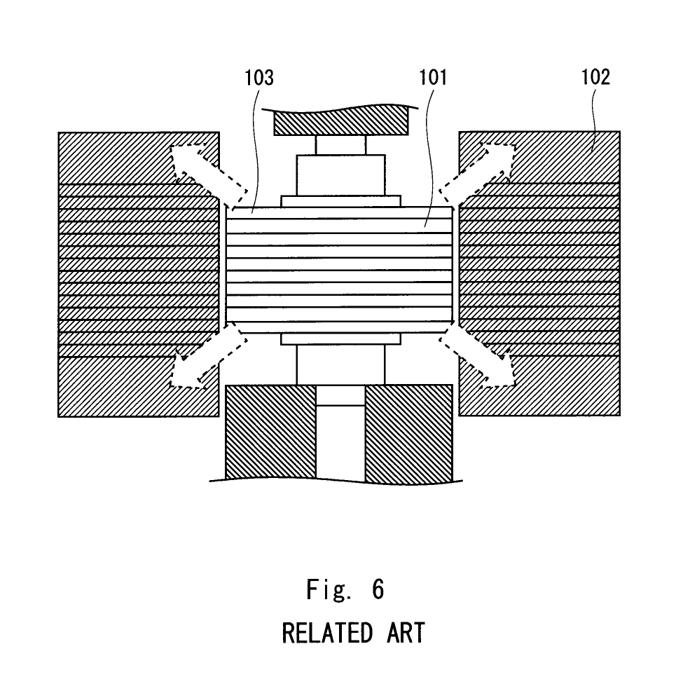

FIG. 7 is a longitudinal cross-sectional view schematically showing a state in which a rotor core that is not equipped with the end plate is magnetized.

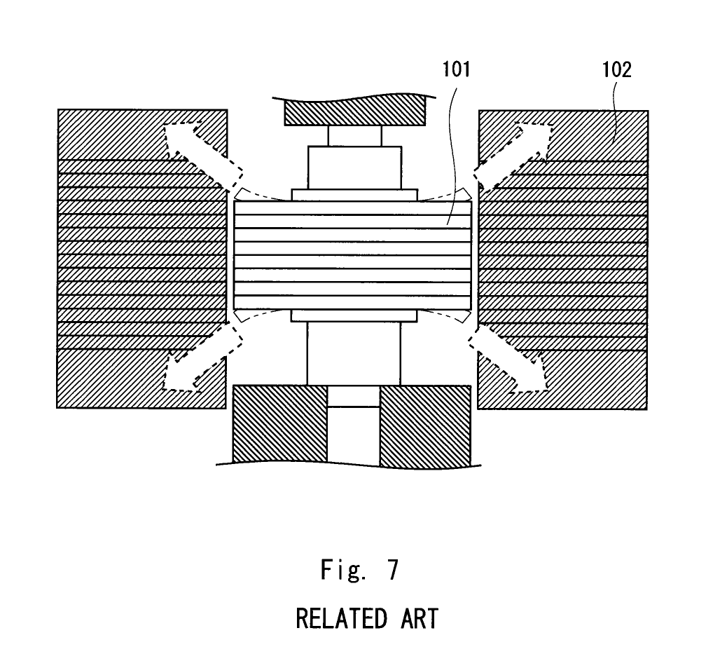

### DESCRIPTION OF THE EXEMPLARY EMBODIMENTS

Hereinafter, an embodiment of the present invention will be described in detail with reference to the drawings. However, the present invention is not limited to the following embodiment. Further, for the sake of clarification of the description, the following description and the drawings are simplified as appropriate.

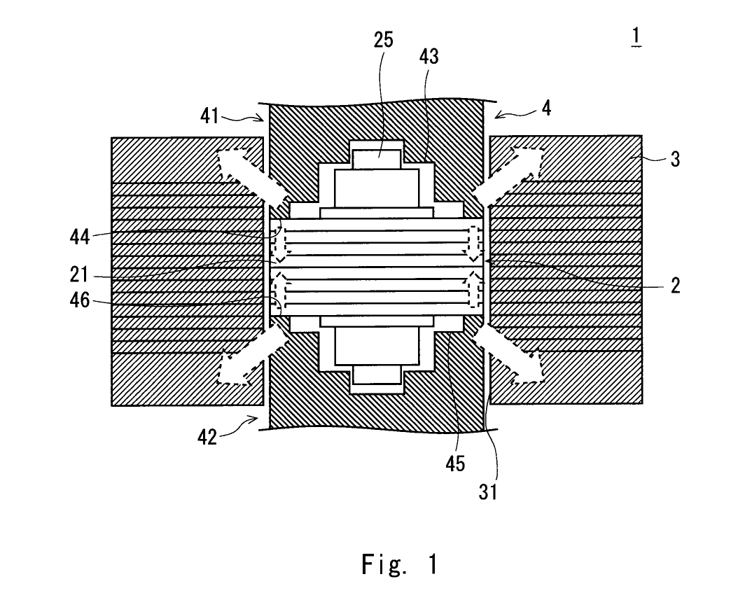

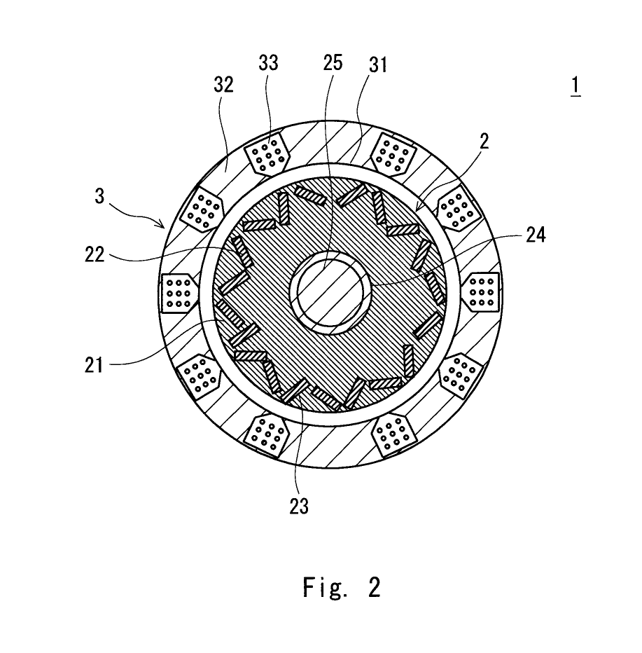

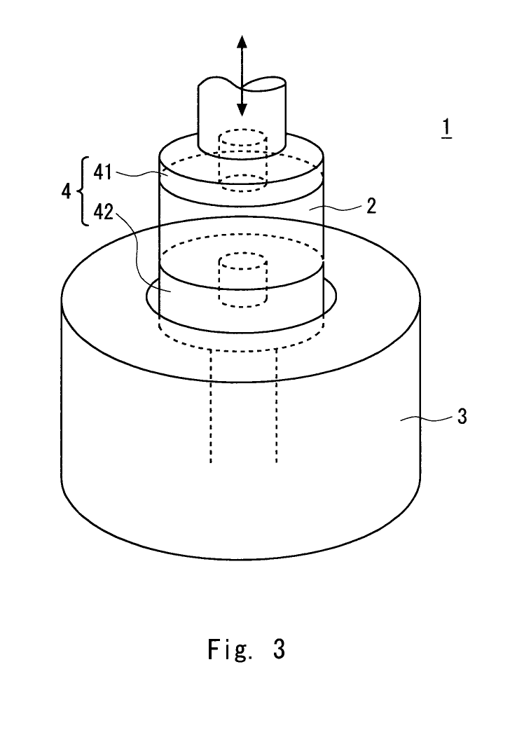

First, a magnetizing device of a rotor core (hereinafter may be simply referred to as a magnetizing device) according to this embodiment will be described. FIG. 1 is a longitudinal cross-sectional view schematically showing a state in which the rotor core is magnetized using the magnetizing device according to this embodiment. FIG. 2 is a parallel cross-sectional view schematically showing a state in which the rotor core is magnetized using the magnetizing device according to this embodiment. FIG. 3 is a perspective view schematically showing the magnetizing device and the rotor core according to this embodiment.

A magnetizing device 1 includes, as shown in FIGS. 1 to 3, a magnetizing yoke 3 to magnetize a rotor core 2, and a holding means 4. The rotor core 2 has a configuration in which, as is similar to a typical rotor core 2, magnet materials 22 are inserted into electromagnetic steel sheets 21 that are laminated and are fixed to the electromagnetic steel sheets 21.

More particularly, magnet insertion holes 23 and an axial hole 24 are formed in the electromagnetic steel sheets 21 that are laminated. The magnet insertion holes 23 are disposed spaced apart from one another near the peripheries of the electromagnetic steel sheets 21 when seen from a direction in which the electromagnetic steel sheets 21 are laminated, and extend in the direction in which the electromagnetic steel sheets 21 are laminated. The magnet materials 22 are inserted into the magnet insertion holes 23 and are fixed to the magnet insertion holes 23.

However, the arrangement and the like of the magnet materials 22 are not limited to those shown in FIG. 2.

The axial hole 24 is arranged substantially at the center of the electromagnetic steel sheets 21 when seen from the direction in which the electromagnetic steel sheets 21 are laminated, and extends in the direction in which the electromagnetic steel sheets 21 are laminated. When a rotor shaft 25 is inserted into the axial hole 24 and is fixed to the axial hole 24, it is possible to form a rotor using the above rotor core 2.

The magnetizing yoke 3 is used to magnetize the magnet materials 22 of the rotor core 2 and includes, as is similar to a typical magnetizing yoke, a core part 32 including an insertion hole 31 into which the rotor core 2 is inserted and a coil part 33 formed in the core part 32. However, the arrangement and the like of the coil part 33 are not limited to those shown in FIG. 2 and may be changed as appropriate depending on the magnetic pattern or the like of the rotor core 2.

In this embodiment, the insertion hole 31 penetrates through the core part 32 in the vertical direction of the magnetizing device 1, and the rotor core 2 is inserted into the insertion hole 31 in such a way that the direction in which the electromagnetic steel sheets 21 are laminated becomes substantially parallel to the vertical direction of the magnetizing device 1.

According to such a configuration, when the rotor core 2 is inserted into the insertion hole 31 formed in the core part 32 to generate an electric field by the coil part 33, the magnet materials 22 of the rotor core 2 can be magnetized.

The holding means 4 holds the peripheries of the electromagnetic steel sheets 21 that are laminated in the rotor core 2 from the direction in which the electromagnetic steel sheets 21 are laminated. The holding means 4 according to this embodiment includes a first pressing part 41 that presses the peripheries of the electromagnetic steel sheets 21 that are laminated from the upper side of the rotor core 2 and a second pressing part 42 that presses the peripheries of the electromagnetic steel sheets 21 that are laminated from the lower side of the rotor core 2.

The first pressing part 41 is a columnar member that can be inserted into the insertion hole 31 of the magnetizing yoke 3 and includes an accommodation part 43 which accommodates the rotor shaft 25 projected to the upper side from the rotor core 2. The accommodation part 43 includes an opening on the lower surface of the first pressing part 41, and the projection part of the rotor shaft 25 is inserted into the accommodation part 43 from this opening. A periphery of the accommodation part 43 in the first pressing part 41, which is the surface of the first pressing part 41 opposed to the rotor core 2, is a contact surface 44 which contacts with the periphery of the electromagnetic steel sheet 21.

The second pressing part 42 is a columnar member that can be inserted into the insertion hole 31 of the magnetizing yoke 3 and includes an accommodation part 45 which accommodates the rotor shaft 25 projected to the lower side from the rotor core 2. The accommodation part 45 includes an opening on the upper surface of the second pressing part 42, and the projection part of the rotor shaft 25 is inserted into the accommodation part 45 from this opening. A periphery of the accommodation part 45 in the second pressing part 42, which is the surface of the second pressing part 42 opposed to the rotor core 2, is a contact surface 46 which contacts with the periphery of the electromagnetic steel sheet 21.

When the rotor core 2 is held by the first pressing part 41 and the second pressing part 42 from the vertical direction of the magnetizing device 1, the contact surface 44 of the first pressing part 41 and the contact surface 46 of the second pressing part 42 hold the peripheries of the electromagnetic steel sheets 21 that are laminated in the rotor core 2, and the accommodation part 43 of the first pressing part 41 and the accommodation part 45 of the second pressing part 42 accommodate the projection parts of the rotor shaft 25.

At this time, the accommodation part 43 of the first pressing part 41 and the accommodation part 45 of the second pressing part 42 preferably have shapes so that they can sufficiently accommodate the projection parts of the rotor shaft 25. Accordingly, it is possible to definitely make the contact surface 44 of the first pressing part 41 and the contact surface 46 of the second pressing part 42 bring into contact with the electromagnetic steel sheets 21 while preventing the interference between the accommodation part 43 of the first pressing part 41 and the projection part of the rotor shaft 25, and the accommodation part 45 of the second pressing part 42 and the projection part of the rotor shaft 25.

The first pressing part 41 and the second pressing part 42 may be formed of a material that does not inhibit magnetization of the rotor core 2, which is a material that is not a magnetic body. The first pressing part 41 and the second pressing part 42 may be formed of, for example, aluminium or copper.

The first pressing part 41 and the second pressing part 42 are configured to be able to move in the vertical direction of the magnetizing device 1 by an actuator (not shown).

Next, a magnetizing method of the rotor core 2 using the above magnetizing device 1 will be described. First, as shown in FIG. 3, the second pressing part 42 is moved to the upper side of the magnetizing device 1 so that the second pressing part 42 passes through the insertion hole 31 of the magnetizing yoke 3, and the rotor core 2 is placed on the contact surface 46 of the second pressing part 42.

Next, the first pressing part 41 is moved to the lower side of the magnetizing device 1, and the contact surface 44 of the first pressing part 41 is brought into contact with the electromagnetic steel sheet 21 in the uppermost layer in the rotor core 2. Therefore, the peripheries of the electromagnetic steel sheets 21 that are laminated in the rotor core 2 are held between the first pressing part 41 and the second pressing part 42.

Next, the rotor core 2 is moved to the lower side of the magnetizing device 1 in a state in which the rotor core 2 is held by the first pressing part 41 and the second pressing part 42 to insert the rotor core 2 into the insertion hole 31 of the magnetizing yoke 3.

Next, an electromagnetic field is generated by the coil part 33 of the magnetizing yoke 3, and the magnet materials 22 of the rotor core 2 are magnetized.

After that, the rotor core 2 is moved to the upper side of the magnetizing device 1 in a state in which the rotor core 2 is held by the first pressing part 41 and the second pressing part 42, the rotor core 2 is extracted from the insertion hole 31 of the magnetizing yoke 3, and the first pressing part 41 is removed. The rotor core 2 that has been magnetized can therefore be obtained.

According to the magnetizing device 1 and the magnetizing method of the rotor core 2 described above, the rotor core 2 is magnetized in a state in which the peripheries of the electromagnetic steel sheets 21 that are laminated in the rotor core 2 are held by the first pressing part 41 and the second pressing part 42 from the laminating direction of the magnetizing device 1. Accordingly, even when the rotor core 2 is not equipped with the end plate, it is possible to suppress deformation of the electromagnetic steel sheets 21 due to the suction power by the magnetizing yoke 3 when the rotor core 2 is magnetized.

The first pressing part 41 or the second pressing part 42 preferably has a configuration in which it is possible to receive a projection part that is projected in the direction in which the electromagnetic steel sheets 21 are laminated in the rotor core 2.

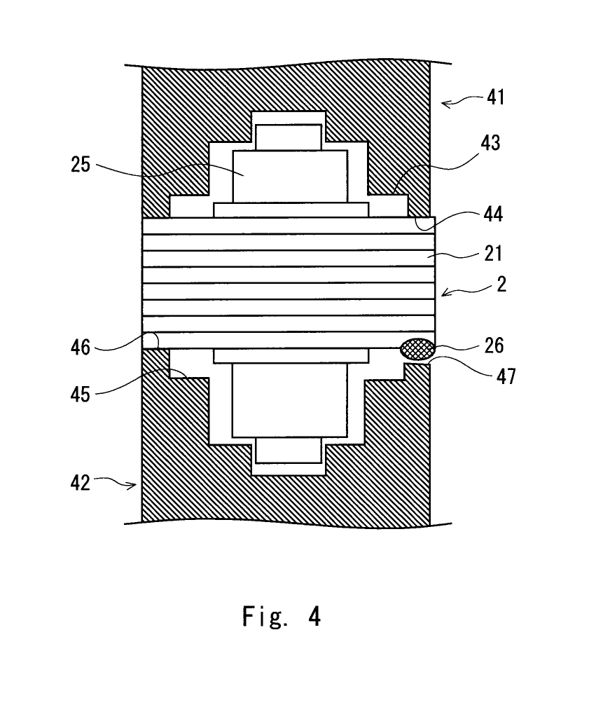

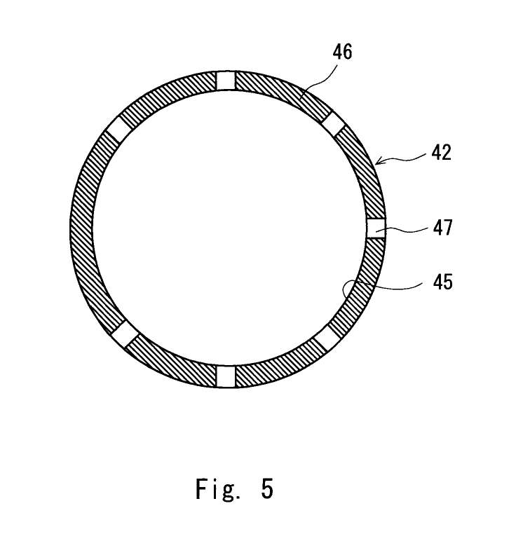

FIG. 4 is a longitudinal cross-sectional view schematically showing a state in which the rotor core is held using holding means that is configured to be able to receive the projection part that is projected from the rotor core. FIG. 5 is a parallel cross-sectional view of the second pressing part configured to be able to receive the projection part that is projected from the rotor core.

In the direction in which the electromagnetic steel sheets 21 are laminated in the rotor core 2, as shown in FIG. 4, a projection part 26 such as a weld part of the core, resin to fix the magnet materials 22, or a swaged portion to fix the electromagnetic steel sheets 21 that are laminated is projected.

The second pressing part 42 according to this embodiment includes, as shown in FIGS. 4 and 5, an accommodation part 47 which accommodates or receives the projection part 26 of the rotor core 2. Accordingly, even when the projection part 26 is projected from the rotor core 2, the peripheries of the electromagnetic steel sheets 21 that are laminated in the rotor core 2 can be appropriately held by the first pressing part 41 and the second pressing part 42.

While only the second pressing part 42 includes the accommodation part 47 in FIG. 4, the first pressing part 41 preferably includes an accommodation part as well. It is sufficient, however, that at least one of the first pressing part 41 and the second pressing part 42 includes a concave part.

The present invention is not limited to the embodiment stated above and may be changed as appropriate without departing from the spirit of the present invention.

While the first pressing part 41 and the second pressing part 42 are configured to be able to move in the vertical direction of the magnetizing device 1, it is sufficient that at least one of the first pressing part 41 and the second pressing part 42 can be moved in the vertical direction of the magnetizing device 1.

While the holding means 4 according to the above embodiment is configured to hold only the peripheries of the electromagnetic steel sheet 21, it may hold other regions as well.

While the first pressing part 41 and the second pressing part 42 according to the above embodiment are formed of columnar members, they may be formed of cylindrical members. In summary, it is sufficient that at least the peripheries of the electromagnetic steel sheets 21 can be held by the first pressing part 41 and the second pressing part 42.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A magnetizing device of a rotor core in which electromagnetic steel sheets are laminated, the magnetizing device comprising:
a magnetizing yoke to magnetize the rotor core; and
a holding part for holding peripheries of the electromagnetic steel sheets that are laminated from a direction in which the electromagnetic steel sheets are laminated.

2. The magnetizing device of the rotor core according to claim 1, wherein an accommodation part that accommodates a projection part that is projected in the direction in which the electromagnetic steel sheets are laminated from the rotor core is formed on a plane of the holding part that is opposed to the electromagnetic steel sheets.

3. A magnetizing method of a rotor core in which electromagnetic steel sheets are laminated, the magnetizing method comprising holding peripheries of the electromagnetic steel sheets that are laminated from a direction in which the electromagnetic steel sheets are laminated when the rotor core is magnetized.
